(19) United States
(12) Patent Application Publication
(10) Pub. No.: US 2026/0240088 A1
(43) Pub. Date: Aug. 20, 2026

(54) BLENDED SOD AND SPRIGS AND PRODUCTION OF BLENDED SOD AND SPRIGS

(71) Applicant: Bayside Sod, Inc., Bradenton, FL (US)

(72) Inventor: Tiffany A. Bailey, Myakka City, FL (US)

(21) Appl. No.: 19/276,273

(22) Filed: Aug. 22, 2025

Related U.S. Application Data
(60) Provisional application No. 63/759,786, filed on Feb. 18, 2025.

(51) Int. Cl. A01G 20/10

(52) U.S. Cl. CPC A01G 20/10

(57) ABSTRACT

A method of manufacturing a mixed-cultivar sod includes: combining at least a first sod piece of a first cultivar and at least a second sod piece of a second cultivar into a mass; chopping the mass into a sprig combination, the sprig combination comprising sprigs of the first cultivar and sprigs of the second cultivar; and planting the sprig combination into a cultivation area. The planted sprig combination is grown into a first generation mixed-cultivar sod in the cultivation area. At least a first harvest of mixed cultivar sod is harvested from the first generation mixed-cultivar sod in the cultivation area. A second generation or more of mixed-cultivar sod may be grown in the harvest area of the cultivation area by growth migration into the harvest area by the sod left in-situ. Cut sod sections composed of sprigs from at least two cultivars of grass are accordingly made available.

### CROSS-REFERENCE TO RELATED APPLICATION

This application claims the benefit of priority of U.S. provisional patent application No. 63/759,786, titled “Blended Sod and Sprigs and Production of Blended Sod and Sprigs,” filed on Feb. 18, 2025, which is incorporated herein in its entirety by this reference.

### TECHNICAL FIELD

The present disclosure relates to the horticulture of turfgrass sod. More particularly, the present disclosure relates to turfgrass in sod and other forms having blended components and the production thereof.

### BACKGROUND

Vegetative turfgrass plants having a single genetic identity are available. Once grown, they provide for a lawn that grows consistently in rate and appearance. Seed mixtures are also available for growing attractive lawns with reduced vulnerabilities to diseases and insects. Care requirements of mixed grass lawns are typically lower than that of a single grass variety lawn. Mixed lawns are more forgiving and can provide the benefits of several strains or species, producing a versatile, healthy and attractive lawn. Single variety lawns can look beautifully uniform when healthy and properly maintained but are more susceptible to insect and disease and can require care at levels burdensome to homeowners.

A grass seed mixture can include a combination of two or more strains of a same species. This provides variation while producing a uniform looking lawn with enhanced insect and disease tolerance relative to a single strain, requiring less care and maintenance than a single variety lawn. A grass seed mixture can also include a combination of two or more genetic species, providing genetic diversity and elevating the insect and disease tolerance, which will in turn reduce the care and maintenance required by a lawn relative to a single variety lawn.

Growing a lawn from seed takes time. Seedlings may be seen in as little as two to three weeks from planting, and a month or more can pass before grass grown from seed reaches a height that can be mowed. A lawn with a truly uniform and mature appearance can take longer, such as several months. Storm conditions can cause the loss of a seed investment if they occur before grass is well grown, washing away seeds, small seedlings and topsoil, which is protected by a healthy lawn.

Some grasses are essentially only available as sod, plugs, or sprigs, referring for example to cultivars. These are propagated by continued growth and harvesting. A cultivar is typically available as a cultivated plant as sod, sprig, or plug and is propagated by replanting in lieu of seeding. Cultivars can be selected for desired traits and can be trusted to retain those traits when propagated because genetic stability without cross breeding is assured by vegetative production. Cultivar production includes division, root and stem cuttings, offsets, grafting, tissue culture, and carefully controlled seed production. St. Augustine is a Floratam variety that is designed for weed control, insect resistance, and reduced mowing as it grows slowly.

Sod is preferred by some to meet a scheduled for sale offering of a property, or otherwise avoid the time required to sprout and grow a new lawn from seed. Sod is available, however, in only single variety grass. Thus currently available sod, while meeting a need for immediate appearance, does not provide the benefits of grass mixtures. There are no commercially available St. Augustine seeds are not commercially available. St. Augustine lawns are only established vegetatively (by sprigs, plugs, or sod).

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

A method of manufacturing a mixed-cultivar sod, according to at least one embodiment, includes: combining at least a first sod piece of a first cultivar and at least a second sod piece of a second cultivar into a mass; chopping the mass into a sprig combination, the sprig combination comprising sprigs of the first cultivar and sprigs of the second cultivar; and planting the sprig combination into a cultivation area. The planted sprig combination is grown into a first generation mixed-cultivar sod in the cultivation area. At least a first harvest of mixed cultivar sod is harvested from the first generation mixed-cultivar sod in the cultivation area.

Harvesting at least a first harvest of mixed cultivar sod may include cutting sod pieces of the grown first generation mixed-cultivar sod from a harvest area of the cultivation area.

Cutting sod pieces of the grown first generation mixed-cultivar sod from the harvest area of the cultivation area may be conducted while leaving a growing portion of the first generation mixed-cultivar sod in-situ in the cultivation area.

The harvest area of the cultivation area may include at least one harvest strip of the cultivation area; and the growing portion of the first generation mixed-cultivar sod left in-situ in the cultivation area may include at least one plot of growing first generation mixed-cultivar sod adjacent the at least one harvest strip.

A second generation mixed-cultivar sod may be grown in the harvest area of the cultivation area by growth migration into the harvest area by the first generation mixed-cultivar sod left in-situ in the cultivation area, and harvested therefrom.

Harvesting at least a second harvest of mixed cultivar sod may include cutting sod pieces of the second generation mixed-cultivar sod from the harvest area of the cultivation area.

Cutting sod pieces of the second generation mixed-cultivar sod from the harvest area of the cultivation area may include leaving the growing portion of the first generation mixed-cultivar sod in-situ in the cultivation area.

Combining at least the first sod piece of a first cultivar and at least the second sod piece of the second cultivar into a mass may include stacking the first sod piece and the second sod piece.

Combining at least the first sod piece of a first cultivar and at least the second sod piece of the second cultivar into a mass may include shuffling multiple sod pieces of a first cultivar with multiple sod pieces of a second cultivar.

Stacking the first sod piece and the second sod piece may include stacking vertically adjacent or stacking horizontally adjacent.

Combining at least the first sod piece of the first cultivar and at least the second sod piece of the second cultivar into a mass may include inputting the first sod piece and the second sod piece into a sprigging machine consecutively or concurrently.

The first cultivar may include or consist of a first genotype, and the second cultivar may include or consist of a second genotype different from the first.

In at least one embodiment, to which the above examples and options apply as well, a method of manufacturing a mixed-cultivar sod includes combining at least a first sample of a first cultivar and at least a second sample of a second cultivar into a mass, and mixing the mass into a sprig combination, the sprig combination comprising sprigs of the first cultivar and sprigs of the second cultivar; and planting the sprig combination into a cultivation area. The planted sprig combination is grown into a first generation mixed-cultivar sod in the cultivation area. At least a first harvest of mixed cultivar sod is harvested from the first generation mixed-cultivar sod in the cultivation area.

A blended grass stock, in at least one embodiment, includes sprigs having multiple genotypes. The sprigs having the multiple genotypes may be in sod form. Sprigs having multiple identity species or strains can be separated from soil and/or other growth media. Multiple genotypes may be mixed in same or similar ratios. Sprigs having multiple identity species or strains may be left in-situ in a medium in which they were grown for regrowth by migration into adjacent harvested areas. A sprigging machine may be loaded with sprigs having multiple genotypes.

The above summary and below descriptions are to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The following descriptions are to be read in view of the drawings, which illustrate some, but not all, embodiments and features as briefly described below. The descriptions herein, however, are not limited to only those embodiments and features explicitly illustrated.

FIG. 1 represents starting sod in four components, for example on pallets.

FIG. 2 represents sprig planting of each of the four components in separate cultivation areas without intermingling.

FIG. 3 represents the cultivation areas of FIG. 2, each fully grown and ready for harvesting.

FIG. 4 represents sod batches each from one of the four sod components of FIG. 1 produced according to FIGS. 2 and 3 and harvested as sod pieces.

FIG. 5 represents a combined sod batch in which the sod components of FIG. 4 are arranged and uniformly shuffled into a combined mass or deck.

FIG. 6 represents a combination of the sod batch(es) of FIG. 4 or 5 entering a sprig planting machine or mixing process for planting.

FIG. 7 represents sprig planting of the combined deck of FIG. 5, in which the four components are intermingled together for growth in a cultivation area such as a field, for example by the sprig planting machine or mixing process represented by FIG. 6.

FIG. 8 represents the field or growth area of FIG. 6, in which the four components are each fully grown and intermingled as a first generation of mixed sod.

FIG. 9 represents the field or growth area of FIG. 7, in which at least a first harvest of the first generation of mixed sod has been harvested, with ribbons of the first generation of mixed sod remaining in-situ for regrowth into the harvested areas.

FIG. 10 represents a produced blended sod batch or other blended sprig stock inventory, in which the four sod components of FIG. 1 are intermingled in each harvested sod piece or sample.

FIG. 11 represents the growing of at least a second generation mixed-cultivar sod in the harvested area of FIG. 9 by the first generation mixed-cultivar sod left in-situ in the cultivation area.

### DETAILED DESCRIPTIONS

These descriptions, of which the drawings are a part, are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Any materials described are provided as non-limiting examples except where and if their inclusion is positively and unambiguously asserted. Once materials and arrangements are described herein with reference to any structures and elements thereof, for example in in any particular drawing, such descriptions apply as well to any further same or similar structures and elements that may appear in other drawings.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

An inventive blended sprig stock is produced by an inventive process described herein. The below descriptions refer to a blend produced with four components for description of at least one embodiment each of a product and method. An inventive blended sprig stock according to these descriptions can have less or more than four components. Blended sprig stock as described herein can be produced, for example as sod retaining the growth soil of the blended grass in flat or rolled sod pieces. Handled and provided as sod, the blended sprig stock provides what may be the highest likelihood of success by providing the sprigs in a from that can be kept moist and can be briefly stored and transported. Blended sprig stock as described herein can as well be delivered or rendered in other forms. By producing and offering blended sprig stock, for example in sod form, the benefits of a multi-grass lawn are accessible without the time and uncertainty disadvantages of planting seed.

An inventive blended sprig stock and methods for production thereof need not literally ever be implemented as expressly illustrated in the drawings, in which rectangular and linear graphical representations are shown. The drawings are to be taken as conceptual, representative, exemplary, and non-limiting. Each drawing nonetheless does literally represent at least an embodiment of its illustrated subject matter.

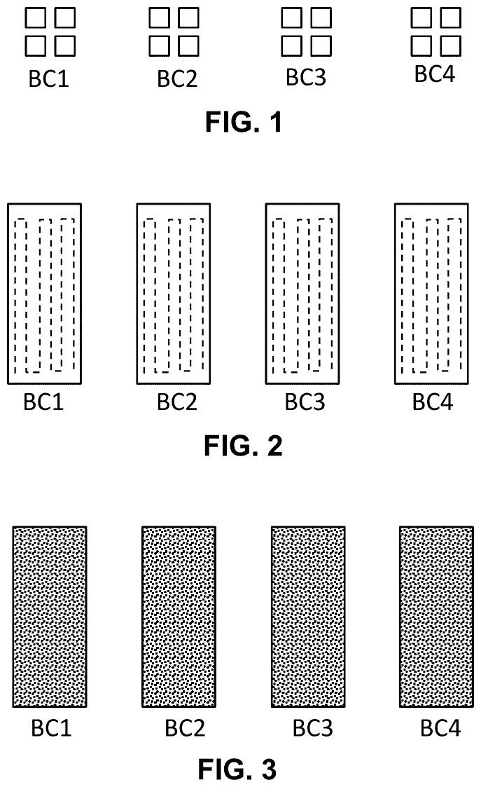

FIG. 1 represents starting material as sod or other sprig samples in four separate components before blending, referenced as blend component one (BC1), blend component two (BC2), blend component three (BC3), and blend component one (BC4). This starting material variety can be grown or otherwise procured, for example on pallets and/or as flat or rolled stock. The components are initially separate.

The components in some examples are all different cultivars, in which examples the four components are from four genotypes, and each genotype becomes a blend component. In some embodiments, one or more of the components, referenced as the components BC1-BC4 without limiting the number thereof to four, are sourced as St. Augustine cultivars. For example, one, more than one, or all of the blend components can be cultivars of St. Augustine grass, including standard and dwarf cultivars, including without limitation Raleigh, Palmetto, Mercedes, Bitterblue, Floratam, Jade, Captiva, Delmar Seville, Sapphire, CitraBlue, ProVista, and Seville. Four components are expressly represented in the drawings. These descriptions relate to any plural number of components by which a blended sod product is ultimately produced including plural numbers less than four and plural numbers greater than four.

FIG. 2 represents sprig planting of each of the four components in separate growth areas without intermingling. The dashed lines represent an exemplary dispensation pattern as delivered to each respective growth area, for example using a conventional sprig planting machine by which each component, BC1, BC2, BC3 and BC4, is individually processed and planted. The dashed lines in each represent exemplary linear travel paths without limiting any actual planting process as such. A sprigging machine generally chops up or otherwise breaks up source sod pieces into sprigs and essentially plants the same into a cultivation area as the machine travels, dropping original soil of the source sod pieces as it travels. These descriptions relate as well to any other machine or mode of planting sprigs.

FIG. 3 represents the growth areas of FIG. 2, each having its fully grown grass component ready for harvesting, for example as sod. To provide a uniform height among the several components, they may be mowed at a preferred height soon before harvesting.

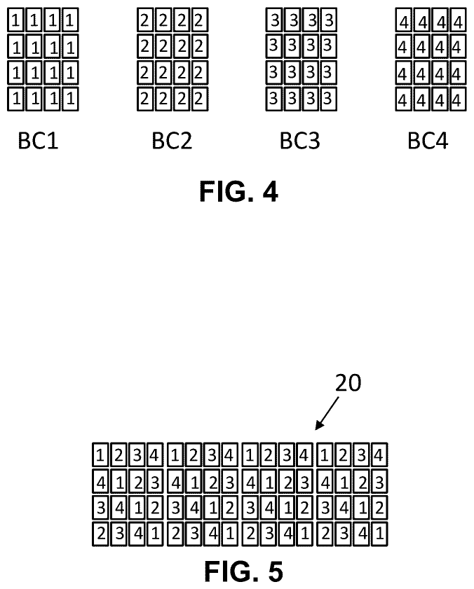

FIG. 4 represents sod batches each from one of the four sod components, referenced as varieties BC1, BC2, BC3, and BC4, each produced for example according to FIGS. 2 and 3 and harvested as sod pieces, for example by a sod harvesting machine, which typically lifts sod into slabs or rolls. Each individual sod piece is referenced as 1, 2, 3 or 4 as short notation in correspondence with the respective components BC1, BC2, BC3 and BC4.

FIG. 5 represents a combined sod batch 20 in which the sod components of FIG. 4 are shuffled and/or stacked vertically and/or horizontally and are ready for the planting of a sprig blend. The combined sod batch of FIG. 5 can refer to any physically shuffled deck prior to loading onto a sprig planting machine and delivered as such to a growth area. The combined sod batch 20 of FIG. 5 can represent at least the shuffling of the sod components of FIG. 4 as they are loaded together into a sprig planting machine or otherwise organized for planting. The illustrated representation is to be taken both as broadly representative of many embodiments and as literal with respect to at least one embodiment of the represented subject matter.

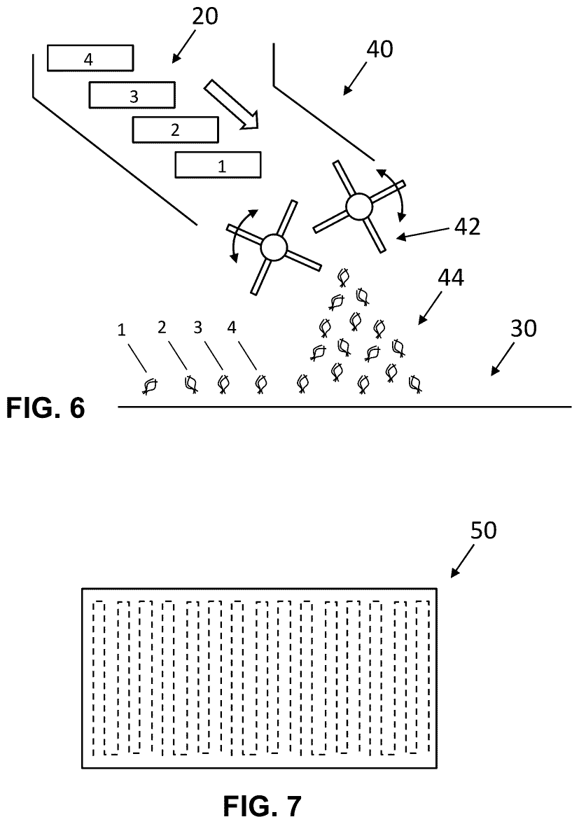

FIG. 6 represents chopping and sprig planting of a portion of the combined deck 20 of FIG. 5, in which the four components are intermingled together for growth and planted into a cultivation area 30. In the illustrated non-limiting representation, the sod mass represented by illustrated portion of the combined deck 20 is input into a sprigging machine 40 having chopping or mixing elements 42 that produce a mixture of sprigs 44 from the sod mass. Individual sprigs are referenced as 1, 2, 3 or 4 in FIG. 6 in accordance with the short notation in correspondence with the respective components BC1, BC2, BC3 and BC4.

FIG. 7 represents sprig planting, for example as implemented in FIG. 6, of the combined deck of FIG. 5. In FIG. 7, the four components are intermingled together for growth in a cultivation area 50 such as a field or portion thereof, for example by a sprig planting machine. The dashed lines in each represent exemplary linear travel paths without limiting any actual planting process as such.

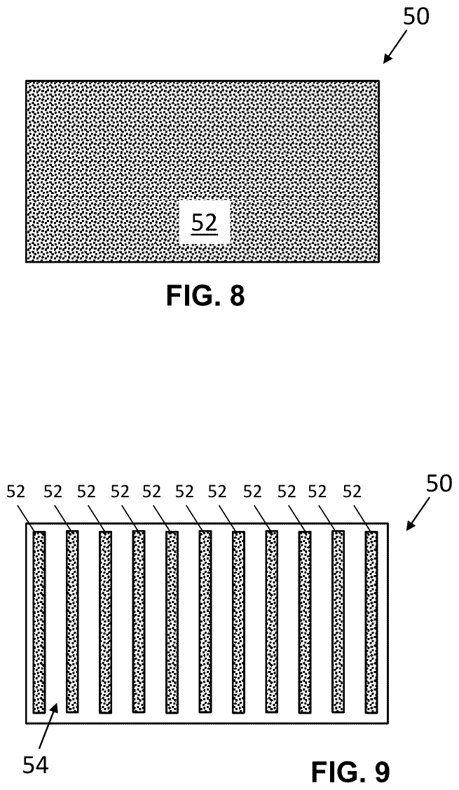

FIG. 8 represents the cultivation area 50 of FIG. 6, in which the four components (BC1-BC4) are each fully grown, intermingled, and prepared for harvesting, for example as a first generation of crop 52 such as a mixed-cultivar sod.

FIG. 9 represents the cultivation area 50 of FIG. 7, in which intermingled sod strips or pieces have been harvested, from harvest areas 54, for example by a sod harvesting machine. Patches of intermingled sod illustrated as ribbons of the first generation of crop 52 intentionally remain in-situ for regrowth by migration into the harvest areas 54 by the first generation mixed-cultivar crop 52 left in-situ in the cultivation area 50. The harvest area 54 of the cultivation area 50 in FIG. 9 is represented as harvest strips of the cultivation area, the growing portion of the crop 52 of the first generation mixed-cultivar sod left in-situ in the cultivation area 50 is represented as plots of growing first generation mixed-cultivar sod adjacent and alternating with the harvest strips. The arrangement leaves the crop 52 of the first generation mixed-cultivar sod left in-situ distributed as beneficial for regrowth by migration in the harvest area 54.

FIG. 9 thus represents an inventive and valuable physical product or arrangement, which need not literally be implemented as expressly illustrated in the drawing as a rectangular plot with linear ribbons. The linear ribbons remain as a growing portion of the first generation of crop 52 such as a mixed-cultivar sod.

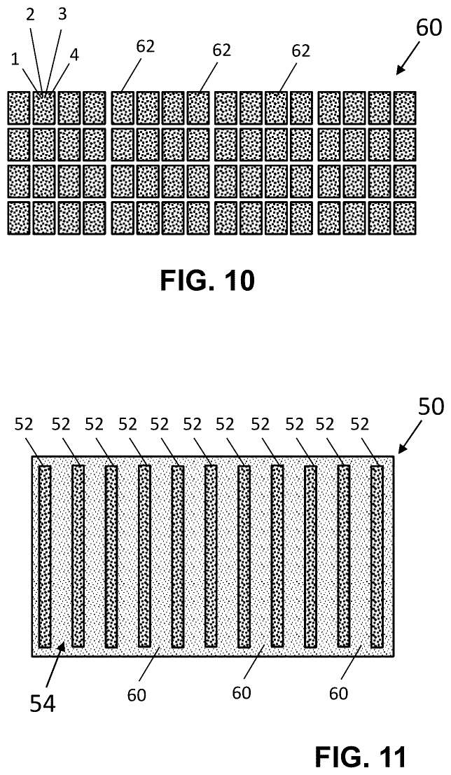

FIG. 10 represents a produced blended sod batch or inventory 60, in which the four sod components (1-4) of FIG. 1 (BC1-BC4) are intermingled in each harvested blended sod piece 62 or blended sprig stock sample in other form. As in FIG. 4, the produced sod pieces or blended sprig stock samples represented in FIG. 10 in rectangular form need not literally ever be implemented as expressly illustrated in the drawing. At least one embodiment of a harvested product is nonetheless represented, for example as rectangular sod pieces dimensioned as sixteen inches by twenty-four inches each.

Similarly, without implying limitation, the in-situ ribbons of the first generation of crop 52 represented in FIG. 9 may be two inches wide and of any length according to preference or dimensions of a cultivation area 50. Thus FIG. 9, as with the other drawings, is not necessarily drawn to scale. A regrowth cycle by way of the in-situ ribbons or patches may be repeated for several harvests and/or several years.

FIG. 11 represents the growing of at least a second generation mixed-cultivar sod 60 in the harvest area of the cultivation area 54 by growth migration into the harvest area 54 by the first generation mixed-cultivar sod 52 left in-situ in the cultivation area. Once the second generation of mixed-cultivar sod 60 is grown, the cycle represented by FIGS. 8-11 can be repeated such that any number of generations of mixed-cultivar sod is represented.

To maintain a preferred balance of the blend components in a final produced sod batch, any given cultivation area may be cleared occasionally or periodically of the remaining ribbons or entire grown stock. This prevents the components from becoming over-dominant with respect to any of the blend components, as one or more may grow fasters than others. Plant contamination is also possible in any open area. Once a cultivation area is cleared or its foliage otherwise eliminated, processes described and implied herein can begin again with new stock components of a same or different variety with respect to the number of components and their ratios. The drawings expressly disclose or imply a uniform ratio balance of the four components as twenty-five percent each. Other numbers of components, and the relative ratios of the components of any number, are all within the scope of these descriptions.

The term sprig is used herein to describe at least separated and chopped stock pieces, which may each be of a single identity with regard to species and/or strains thereof, for example as prepared by a sprigging machine as planting occurs. Sprig herein refers to plant samples partly or completely relieved of soil or other growth medium. Sprig herein also refers to blended stock at least where described as such, for example as may be planted by a sprigging machine using the product of, for example, FIG. 6. Sprig furthermore refers to plant elements in a sod matrix, which may have intertwined roots and above-ground structures among single plants not easily separated by a machine or other mode.

Several distinct inventive and valuable properties are described and/or inferred in these descriptions. These include at least:
a combined sod batch, as represented in FIG. 5, in which sod components in any plural number are arranged into a combined mass or deck;
a sprig planting, as represented in FIG. 6 as both product and process, of any plural number of components intermingled or being intermingled together;
a field or growth area, as represented in FIGS. 6-8 as both product and process, in which any plural number of components are sown and growing in any stage of progression as at least a first generation of mixed sod;
a cultivation area, as represented in FIG. 9 as both product and process, in which intermingled sod, of a first generation or other, remains as at least one ribbon or other patch between, among, and/or adjacent at least one harvested area for regrowth by migration into the harvested area(s); and
a field or growth area, as represented at least in FIG. 11 as both product and process, in which any plural number of components are sown and growing in any stage of progression as at least a second generation of mixed sod.

Further inventive products are described and/or inferred in these descriptions. These include at least: a blended sod batch or other blended sprig stock inventory, as represented at least in FIG. 10, in which any number of sod components are intermingled, for example uniformly. The product represented can be prepared and made available in slab rectangular form as illustrated, as one more rolls, and in other forms.

Inventive products described and/or inferred in these descriptions include as well turfgrass sod products, for example prepared for commercial sale, in which a cut sod section is composed of sprigs from at least two cultivars of St. Augustine grass. The sprigs are combined prior to planting in a way that results in substantially uniform intermixing of the cultivars throughout the sod section. The sod section is suitable for consumer installation and exhibits improved resilience due to the cultivar diversity. The sod can be harvested from a field grown using alternating regrowth and harvest strips. The product can be labeled and marketed as a proprietary blend of St. Augustine grass cultivars. The cultivars can differ in one or more of the following: growth rate, drought resistance, pest resistance, and blade width. The turfgrass sod product benefits from the strengths of each included cultivar.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A method of manufacturing a mixed-cultivar sod, the method comprising:
combining at least a first sod piece of a first cultivar and at least a second sod piece of a second cultivar into a mass;
chopping the mass into a sprig combination, the sprig combination comprising sprigs of the first cultivar and sprigs of the second cultivar;
planting the sprig combination into a cultivation area;
growing the planted sprig combination into a first generation mixed-cultivar sod in the cultivation area; and
harvesting at least a first harvest of mixed cultivar sod from the first generation mixed-cultivar sod in the cultivation area.

2. The method of manufacturing a mixed-cultivar sod of claim 1, wherein harvesting at least a first harvest of mixed cultivar sod comprises cutting sod pieces of the grown first generation mixed-cultivar sod from a harvest area of the cultivation area.

3. The method of manufacturing a mixed-cultivar sod of claim 2, wherein cutting sod pieces of the grown first generation mixed-cultivar sod from the harvest area of the cultivation area comprises leaving a growing portion of the first generation mixed-cultivar sod in-situ in the cultivation area.

4. The method of manufacturing a mixed-cultivar sod of claim 3, wherein:
the harvest area of the cultivation area comprises at least one harvest strip of the cultivation area; and
the growing portion of the first generation mixed-cultivar sod left in-situ in the cultivation area comprises at least one plot of growing first generation mixed-cultivar sod adjacent the at least one harvest strip.

5. The method of manufacturing a mixed-cultivar sod of claim 3, further comprising growing a second generation mixed-cultivar sod in the harvest area of the cultivation area by growth migration into the harvest area by the first generation mixed-cultivar sod left in-situ in the cultivation area.

6. The method of manufacturing a mixed-cultivar sod of claim 5, further comprising harvesting a second harvest of mixed cultivar sod from the grown second generation mixed-cultivar sod.

7. The method of manufacturing a mixed-cultivar sod of claim 6, wherein harvesting at least a second harvest of mixed cultivar sod comprises cutting sod pieces of the second generation mixed-cultivar sod from the harvest area of the cultivation area.

8. The method of manufacturing a mixed-cultivar sod of claim 7, wherein cutting sod pieces of the second generation mixed-cultivar sod from the harvest area of the cultivation area comprises leaving the growing portion of the first generation mixed-cultivar sod in-situ in the cultivation area.

9. The method of manufacturing a mixed-cultivar sod of claim 1 wherein combining at least the first sod piece of a first cultivar and at least the second sod piece of the second cultivar into a mass comprises stacking the first sod piece and the second sod piece.

10. The method of manufacturing a mixed-cultivar sod of claim 1, wherein combining at least the first sod piece of a first cultivar and at least the second sod piece of the second cultivar into a mass comprises shuffling multiple sod pieces of a first cultivar with multiple sod pieces of a second cultivar.

11. The method of manufacturing a mixed-cultivar sod of claim 9, wherein stacking the first sod piece and the second sod piece comprises stacking vertically adjacent or stacking horizontally adjacent.

12. The method of manufacturing a mixed-cultivar sod of claim 1, wherein combining at least the first sod piece of the first cultivar and at least the second sod piece of the second cultivar into a mass comprises inputting the first sod piece and the second sod piece into a sprigging machine consecutively or concurrently.

13. The method of manufacturing a mixed-cultivar sod of claim 1, wherein:
the first cultivar comprises a first genotype;
the second cultivar comprises a second genotype; and
the first harvest of mixed cultivar sod comprises at least the first genotype and the second genotype.

14. A method of manufacturing a mixed-cultivar sod, the method comprising:
combining at least a first sample of a first cultivar and at least a second sample of a second cultivar into a mass;
mixing the mass into a sprig combination, the sprig combination comprising sprigs of the first cultivar and sprigs of the second cultivar;
planting the sprig combination into a cultivation area;
growing the planted sprig combination into a first generation mixed-cultivar sod in the cultivation area; and
harvesting at least a first harvest of mixed cultivar sod from the grown first generation mixed-cultivar sod in the cultivation area.

15. The method of manufacturing a mixed-cultivar sod of claim 14, wherein harvesting at least a first harvest of mixed cultivar sod comprises cutting sod pieces of the first generation mixed-cultivar sod from a harvest area of the cultivation area.

16. The method of manufacturing a mixed-cultivar sod of claim 15, wherein cutting sod pieces of the first generation mixed-cultivar sod from the harvest area of the cultivation area comprises leaving a growing portion of the first generation mixed-cultivar sod in-situ in the cultivation area.

17. The method of manufacturing a mixed-cultivar sod of claim 16, wherein:
the harvest area of the cultivation area comprises at least one harvest strip of the cultivation area; and
the growing portion of the first generation mixed-cultivar sod left in-situ in the cultivation area comprises at least one plot of growing first generation mixed-cultivar sod adjacent the at least one harvest strip.

18. The method of manufacturing a mixed-cultivar sod of claim 16, further comprising growing a second generation mixed-cultivar sod in the harvest area of the cultivation area by growth migration into the harvest area by the growing portion of the first generation mixed-cultivar from the cultivation area.

19. The method of manufacturing a mixed-cultivar sod of claim 18, further comprising harvesting a second harvest of mixed cultivar sod from the grown second generation mixed-cultivar sod.

20. The method of manufacturing a mixed-cultivar sod of claim 19, wherein:
harvesting at least a second harvest of mixed cultivar sod comprises cutting sod pieces of the second generation mixed-cultivar sod from the harvest area of the cultivation area; and
cutting sod pieces of the second generation mixed-cultivar sod from the harvest area of the cultivation area comprises leaving the growing portion of the first generation mixed-cultivar sod in-situ in the cultivation area.
